(19) United States
(12) Patent Application Publication
(10) Pub. No.: US 2024/0411073 A1
(43) Pub. Date: Dec. 12, 2024

(54) PANCHARATNAM-BERRY PHASE OPTICAL ELEMENT AND METHOD OF PRODUCING THE SAME

(71) Applicant: Sharp Display Technology Corporation, Kameyama City (JP)

(72) Inventors: Ryosuke SAIGUSA, Kameyama City (JP); Yuichi KAWAHIRA, Kameyama City (JP); Akira SAKAI, Kameyama City (JP)

(21) Appl. No.: 18/732,729

(22) Filed: Jun. 4, 2024

(30) Foreign Application Priority Data
Jun. 6, 2023 (JP) 2023-093204
Apr. 8, 2024 (JP) 2024-062230

(51) Int. Cl. G02B 5/30

(52) U.S. Cl. CPC G02B 5/3016

(57) ABSTRACT

Provided are a Pancharatnam-Berry phase optical element with less or no occurrence of disclinations and with excellent optical characteristics, and a method of producing a Pancharatnam-Berry phase optical element which is suitable for production of the Pancharatnam-Berry phase optical element above. The Pancharatnam-Berry phase optical element includes: a photoalignment film; and a liquid crystal layer in contact with the photoalignment film. The liquid crystal layer includes alignment domains with reference alignment azimuths of liquid crystal molecules defined by the photoalignment film, the reference alignment azimuths being different from one another. The alignment domains include first alignment domains and second alignment domains, with each of the second alignment domains being positioned between two of the first alignment domains and in contact with each of the two first alignment domains. A difference in reference alignment azimuth between the first alignment domains is not 90°.

### CROSS-REFERENCE TO RELATED APPLICATIONS

The present application claims priority under 35 U.S.C. § 119 to Japanese Patent Application No. 2023-093204 filed on Jun. 6, 2023, and Japanese Patent Application No. 2024-062230 filed on Apr. 8, 2024, the contents of which are incorporated herein by reference in their entirety.

### BACKGROUND OF THE INVENTION

### Field of the Invention

The following disclosure relates to Pancharatnam-Berry phase optical elements and methods of producing the same.

### Description of Related Art

Light modulation elements having multiple focal lengths have been known. For example, JP H09-197363 A discloses a light modulation element including a liquid crystal cell, wherein the liquid crystal cell includes concentrically arranged regions where liquid crystaabaal molecules are arranged, the alignment state of the liquid crystal molecules periodically changes across the regions from the central region toward the peripheral region, and the cycle of change also changes from the center toward the periphery.

### BRIEF SUMMARY OF THE INVENTION

Light modulation elements with a variable focal length have been desired for optical devices such as head-mounted displays (HMDs). In response to the desire, the present inventors focused on Pancharatnam-Berry phase optical elements (PBOEs) and examined methods of providing a liquid crystal layer including multiple alignment domains in a PBOE to achieve a desired optical element. However, disclinations (liquid crystal misalignments) were observed in boundaries of the alignment domains, which made it difficult to achieve a Pancharatnam-Berry phase optical element having favorable optical characteristics.

In response to the above issues, an object of the present invention is to provide a Pancharatnam-Berry phase optical element with reduced occurrence of disclinations and with excellent optical characteristics, and a method of producing a Pancharatnam-Berry phase optical element which is suitable for production of the Pancharatnam-Berry phase optical element.

(1) One embodiment of the present invention is directed to a Pancharatnam-Berry phase optical element including: a photoalignment film; and a liquid crystal layer in contact with the photoalignment film, the liquid crystal layer including alignment domains with reference alignment azimuths of liquid crystal molecules defined by the photoalignment film, the reference alignment azimuths being different from one another, the alignment domains including first alignment domains and second alignment domains, with each of the second alignment domains being positioned between two of the first alignment domains and in contact with each of the two first alignment domains, a difference in reference alignment azimuth between the first alignment domains being not 90°.

(2) In an embodiment of the present invention, the Pancharatnam-Berry phase optical element includes the structure (1), and the first alignment domains include four or more types of alignment domains.

(3) In an embodiment of the present invention, the Pancharatnam-Berry phase optical element includes the structure (1) or (2), and with a predetermined reference azimuth being set to 0°, the first alignment domains include an alignment domain where the reference alignment azimuth is 0° but not an alignment domain where the reference alignment azimuth is 90°.

(4) In an embodiment of the present invention, the structure (1), (2), or (3), and with a predetermined reference azimuth being set to 0°, the first alignment domains include an alignment domain where the reference alignment azimuth is 0° and an alignment domain where the reference alignment azimuth is 80°, 85°, 95°, or 100°.

(5) Another embodiment of the present invention is directed to a Pancharatnam-Berry phase optical element including: a photoalignment film; and a liquid crystal layer in contact with the photoalignment film, the liquid crystal layer including alignment domains with reference alignment azimuths of liquid crystal molecules, defined by the photoalignment film, being different from one another, a difference in reference alignment azimuth between the alignment domains being not 90°.

(6) In an embodiment of the present invention, the Pancharatnam-Berry phase optical element includes the structure (5), and the alignment domains include four or more types of alignment domains.

(7) In an embodiment of the present invention, the Pancharatnam-Berry phase optical element includes the structure (5) or (6), and with a predetermined reference azimuth being set to 0°, the alignment domains include an alignment domain where the reference alignment azimuth is 0° but not an alignment domain where the reference alignment azimuth is 90°.

(8) In an embodiment of the present invention, the Pancharatnam-Berry phase optical element includes the structure (5), (6), or (7), and with a predetermined reference azimuth being set to 0°, the alignment domains include an alignment domain where the reference alignment azimuth is 0° and an alignment domain where the reference alignment azimuth is 80°, 85°, 95°, or 100°.

(9) In an embodiment of the present invention, the structure (1), (2), (3), (4), (5), (6), (7), or (8), and in a plan view of the liquid crystal layer, the alignment domains are arranged in a first direction from one end to the other end in the first direction of the liquid crystal layer.

(10) In an embodiment of the present invention, the Pancharatnam-Berry phase optical element includes the structure (1), (2), (3), (4), (5), (6), (7), or (8), and in a plan view of the liquid crystal layer, the alignment domains are arranged from a center toward an end of the liquid crystal layer, with outer alignment domains surrounding inner alignment domains.

(11) In an embodiment of the present invention, the Pancharatnam-Berry phase optical element includes the structure (1), (2), (3), (4), (5), (6), (7), (8), (9), or (10), and with a portion of the liquid crystal layer adjoining to the photoalignment film being defined as an adjoining portion, the reference alignment azimuth of each of the alignment domains corresponds to an alignment azimuth of liquid crystal molecules in a center of the adjoining portion inside the alignment domain.

(12) Yet another embodiment of the present invention is directed to a method of producing a Pancharatnam-Berry phase optical element, the method including: a photoalignment treatment performed on a photoalignment film, the photoalignment treatment including dividing the photoalignment film into irradiation regions and irradiating the irradiation regions with different polarized lights through a photomask, a difference in polarization direction between the polarized lights applied to the irradiation regions is not 90°.

(13) In an embodiment of the present invention, the method includes the process (12), and each of the irradiation regions includes a non-overlapping region not overlapping another irradiation region and an overlapping region overlapping another irradiation region.

The present invention can provide a Pancharatnam-Berry phase optical element with less or no occurrence of disclinations and with excellent optical characteristics, and a method of producing a Pancharatnam-Berry phase optical element which is suitable for production of the Pancharatnam-Berry phase optical element above.

### BRIEF DESCRIPTION OF THE DRAWINGS

FIG. 1 is a plan view schematically showing liquid crystal alignment in a liquid crystal layer of a PB lens according to an embodiment of the present invention.

FIG. 2 is a plan view schematically showing liquid crystal alignment in a liquid crystal layer of a PB diffraction grating according to the embodiment of the present invention.

FIG. 3A is a view illustrating mask exposure.

FIG. 3B is a view illustrating mask exposure with misaligned photomasks.

FIG. 4 is a view illustrating mask exposure according to the embodiment of the present invention.

FIG. 5 is a schematic view illustrating an example of convergence and divergence of light through a PB lens.

FIG. 6 is a plan view showing an example of a PB lens according to the embodiment of the present invention.

FIG. 7 is a plan view showing another example of a PB lens according to the embodiment of the present invention.

FIG. 8 is an example of a schematic cross-sectional view of a PB lens according to the embodiment of the present invention.

FIGS. 9A, 9B, and 9C are views illustrating an irradiation method with polarized lights in Experimental Example 1.

FIG. 10 is a photograph showing a sample of Experimental Example 1.

FIG. 11 is a photograph showing a sample of Experimental Example 2.

FIG. 12 shows a photomask used for polarized UV light with a polarization direction of 0°.

FIG. 13 shows a photomask used for polarized UV light with a polarization direction of 45°.

FIG. 14 shows a photomask used for polarized UV light with a polarization direction of 90°.

FIG. 15 shows a photomask used for polarized UV light with a polarization direction of 135°.

FIG. 16 is a view illustrating polarized UV irradiation in PB lens production.

FIG. 17 is a photograph of a PB lens of Comparative Example 1 observed with a polarizing microscope.

FIG. 18 is a view illustrating the method of measuring the diffraction efficiency.

FIG. 19 is a view illustrating the positions in a PB lens through which laser light passes in diffraction efficiency measurement.

FIG. 20 is a photograph of a PB lens of Example 1 observed with a polarizing microscope.

FIG. 21 is a view schematically showing liquid crystal alignment in the PB lens of Example 1.

### DETAILED DESCRIPTION OF THE INVENTION

The following describes an embodiment of the present invention. The present invention is not limited to the following embodiment. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

A Pancharatnam-Berry phase optical element (abbreviated as “PBOE”) of the present embodiment includes a photoalignment film and a liquid crystal layer in contact with the photoalignment film. The liquid crystal layer includes alignment domains with reference alignment azimuths of liquid crystal molecules, defined by the photoalignment film, being different from one another.

In a first aspect of the present embodiment, the alignment domains include first alignment domains and second alignment domains, with each of the second alignment domains being positioned between two of the first alignment domains and in contact with each of the two first alignment domains. The difference in reference alignment azimuth between the first alignment domains is not 90°.

A method of producing a PBOE according to the present embodiment includes a photoalignment treatment performed on a photoalignment film. The photoalignment treatment includes dividing the photoalignment film into irradiation regions and irradiating the irradiation regions with different polarized lights through a photomask. The difference in polarization direction between the polarized lights applied to the irradiation regions is not 90°. Each of the irradiation regions of the photoalignment film may include a non-overlapping region (region irradiated with a single polarized light) not overlapping another irradiation region and an overlapping region (region irradiated with overlapping two polarized lights with different polarization directions) overlapping another irradiation region. Alternatively, each of the irradiation regions of the photoalignment film may be a non-overlapping region.

The first alignment domains among the alignment domains are formed according to the irradiation regions (non-overlapping regions) of the photoalignment film each irradiated with a single polarized light. Each of the first alignment domains thus has a reference alignment azimuth according to the polarization direction of the polarized light applied to the non-overlapping region corresponding to the first alignment domain. The second alignment domains are formed according to irradiation regions (overlapping regions) each irradiated with overlapping two polarized lights. Each of the second alignment domains thus has a reference alignment azimuth according to the direction based on the polarization directions of the two polarized lights (for example, a direction in the middle between the two polarization directions) applied to the overlapping region corresponding to the second alignment domain. For example, when irradiation regions are irradiated with overlapping polarized lights with different polarization directions such that two irradiation regions overlap, the second alignment domains are formed according to the overlapping regions. Thus, each of the second alignment domains is positioned between two of the first alignment domains and in contact with each of the two first alignment domains. When the two irradiation regions are irradiated with non-overlapping polarized lights with different polarization directions, the second alignment domains are not formed. In the first aspect of the present embodiment, the second alignment domains may not be interposed between all the first alignment domains.

The alignment azimuth of liquid crystal molecules in each of the first alignment domains and the second alignment domains is not necessarily uniform in the single domain because it is influenced by the alignment azimuth of liquid crystal molecules in an adjacent alignment domain or the strength of the alignment regulating force exerted by the photoalignment film. Thus, the alignment azimuth in an alignment domain is represented by a reference alignment azimuth defined by the photoalignment film. The reference alignment azimuth preferably corresponds to the alignment azimuth of liquid crystal molecules in the center of the domain in a plan view. More preferably, with a portion of the liquid crystal layer adjoining to the photoalignment film being defined as an adjoining portion, the reference alignment azimuth corresponds to the alignment azimuth of liquid crystal molecules in the center of the adjoining portion inside the alignment domain.

The second alignment domains may not be provided. In a second aspect of the present embodiment, a difference in reference alignment azimuth between the alignment domains is not 90°. In other words, the second aspect corresponds to a case where the second alignment domains are not provided and the alignment domains consist only of the first alignment domains. Hereinbelow, the term “first alignment domain” means not only the “first alignment domain” in the first aspect of the present embodiment but also the “alignment domain” in the second aspect of the present embodiment, unless otherwise specified.

The difference in reference alignment azimuth between the first alignment domains is not 90°. The difference in reference alignment azimuth between the first alignment domains can be made other than 90° by irradiating the irradiation regions with polarized lights with different polarization directions such that the difference in polarization direction between the polarized lights is not 90°.

The difference that is “not 90°” or “other than 90°” is preferably 88° (85°+3°) or less or 92° (95°-3°) or more, and when the error is not considered, the difference is preferably 85° or less or 95° or more.

Preferably, with a predetermined reference azimuth being set to 0°, the first alignment domains include an alignment domain where the reference alignment azimuth is 0° but not an alignment domain where the reference alignment azimuth is 90°. More preferably, with the predetermined reference azimuth being set to 0°, the first alignment domains include an alignment domain where the reference alignment azimuth is 0° and an alignment domain where the reference alignment azimuth is 85°, or include an alignment domain where the reference alignment azimuth is 0° and an alignment domain where the reference alignment azimuth is 95°.

The arrangement of the alignment domains is not limited. Preferred arrangements include: (1) an arrangement in which in a plan view of the liquid crystal layer, the alignment domains are arranged in a first direction from one end to the other end in the first direction of the liquid crystal layer; and (2) an arrangement in which in a plan view of the liquid crystal layer, the alignment domains are arranged from the center toward the end of the liquid crystal layer, with outer alignment domains surrounding inner alignment domains.

The PBOE has a periodic alignment pattern of liquid crystal molecules in the liquid crystal layer, and is preferably a half-wave plate.

The PBOE may have any function and may be, for example, a lens or a diffraction grating.

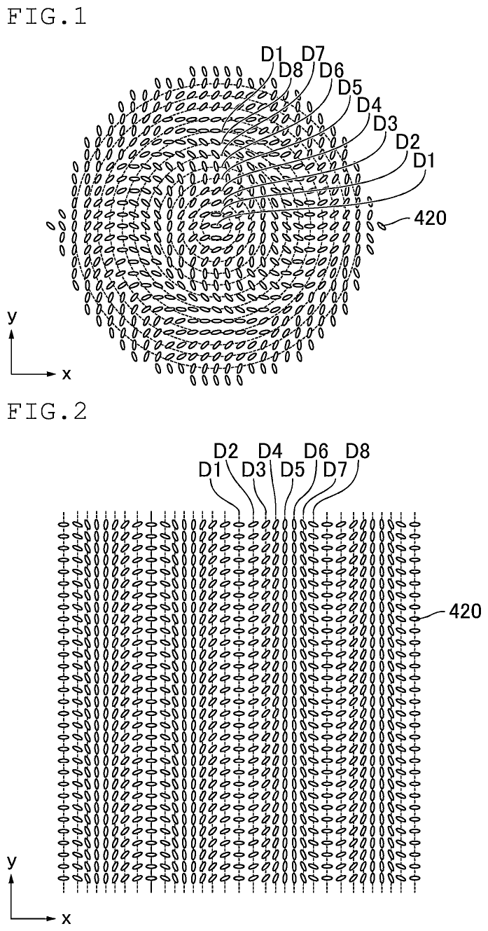

FIG. 1 is a plan view schematically showing liquid crystal alignment in a liquid crystal layer of a PB lens according to the embodiment of the present invention. In a case where the Pancharatnam-Berry phase optical element is a lens, the Pancharatnam-Berry phase optical element is also referred to as a “PB lens”. In the PB lens shown in FIG. 1, alignment domains with reference alignment azimuths of liquid crystal molecules 420 being different from one another are arranged concentrically. The dashed lines in FIG. 1 indicate the center portions of the respective alignment domains. The number of alignment domains from the center and the size of each alignment domain are changed depending on the design of the desired lens (e.g., focal length, lens size). FIG. 1 shows a liquid crystal layer of the PB lens including alignment domains with reference alignment azimuths of 0°, 22.5°, 45°, 65°, 85°, 107.5°, 130°, and 155° (corresponding to the arrangement (2) above). In the PB lens in FIG. 1, the alignment domain D1 where the reference alignment azimuth is 0°, the alignment domain D3 where the reference alignment azimuth is 45°, the alignment domain D5 where the reference alignment azimuth is 85°, and the alignment domain D7 where the reference alignment azimuth is 130° correspond to the first alignment domains, and the alignment domain D2 where the reference alignment azimuth is 22.5°, the alignment domain D4 where the reference alignment azimuth is 65°, the alignment domain D6 where the reference alignment azimuth is 107.5°, and the alignment domain D8 where the reference alignment azimuth is 155° correspond to the second alignment domains.

FIG. 2 is a plan view schematically showing liquid crystal alignment in a liquid crystal layer of a PB diffraction grating according to the embodiment of the present invention. The dashed lines in FIG. 2 indicate the center portions of the respective alignment domains. In a case where the Pancharatnam-Berry phase optical element is a diffraction grating, the Pancharatnam-Berry phase optical element is also referred to as a “PB diffraction grating”. FIG. 2 shows a liquid crystal layer of the PB diffraction grating including alignment domains with reference alignment azimuths of 0°, 22.5°, 45°, 65°, 85°, 107.5°, 130°, and 155° (corresponding to the arrangement (1) above). In the PB diffraction grating in FIG. 2, the alignment domain D1 where the reference alignment azimuth is 0°, the alignment domain D3 where the reference alignment azimuth is 45°, the alignment domain D5 where the reference alignment azimuth is 85°, and the alignment domain D7 where the reference alignment azimuth is 130° correspond to the first alignment domains, and the alignment domain D2 where the reference alignment azimuth is 22.5°, the alignment domain D4 where the reference alignment azimuth is 65°, the alignment domain D6 where the reference alignment azimuth is 107.5°, and the alignment domain D8 where the reference alignment azimuth is 155° correspond to the second alignment domains.

In the PBOE, the reference alignment azimuths of liquid crystal molecules in the liquid crystal layer are controlled by a photoalignment film on which a photoalignment treatment has been performed. When the photoalignment film before the photoalignment treatment is divided into irradiation regions and the irradiation regions are subjected to the photoalignment treatment, which is irradiation with polarized lights with different polarization directions, then the treated photoalignment film exerts its alignment regulating force in different directions in the divided irradiation regions. This enables formation of the first alignment domains with reference alignment azimuths of liquid crystal molecules being different from one another in the plane by patterning. The number of types of the first alignment domains is not limited, and is preferably four or more. In other words, the liquid crystal layer preferably includes four or more types of first alignment domains with reference alignment azimuths of liquid crystal molecules being different from one another.

In the present embodiment, a difference in reference alignment azimuth between the first alignment domains is not 90°. Such first alignment domains can be formed by irradiating the divided irradiation regions with polarized lights adjusted to satisfy the relationship where the difference in polarization direction between the polarized lights is not 90°.

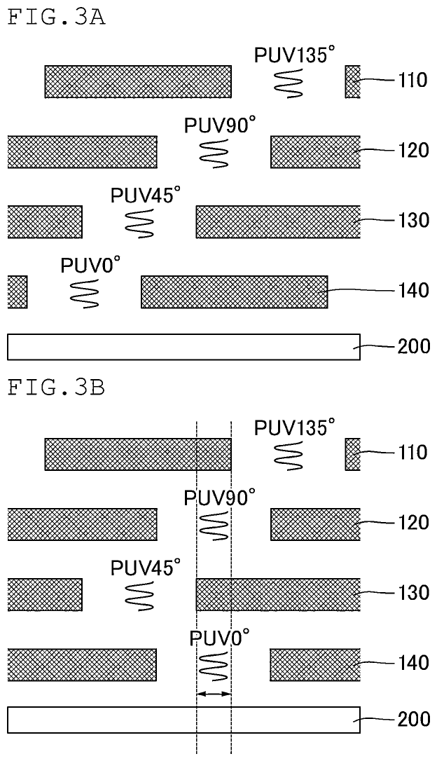

Usually, for better optical characteristics, polarized lights are desirably applied to the photoalignment film with the angles of their polarization directions being set at equal intervals. FIG. 3A is a view illustrating mask exposure. The present inventors produced a PBOE by irradiating a photoalignment film 200 with polarized UV (PUV) lights with polarization directions of 0°, 45°, 90°, and 135° respectively through four photomasks 140, 130, 120, and 110, and they observed disclinations in the PBOE. Through further examination, the inventors found that the disclinations were due to irradiation of the same irradiation region with overlapping polarized UV lights with orthogonal polarization directions such as 0° and 90° or 45° and 135°. In ideal mask exposure as shown in FIG. 3A, the same irradiation region of the photoalignment film 200 is not irradiated with overlapping orthogonal polarized UV lights. In practical process, however, misalignment of photomasks such as a shift of the photomask 140 as shown in FIG. 3B may occur, so that orthogonal polarized UV lights may overlap. Thus, the angle formed between polarized UV lights, which are orthogonal in conventional processes (e.g., two polarized UV lights with polarization directions of 0° and 90°, two polarized UV lights with polarization directions of 45° and) 135°, is changed not to be 90° (e.g., 85° or smaller) (for example, the polarization directions of the polarized UV lights are changed from 90° to 80° and from 135° to 125° such that the angle formed between the two polarized UV lights with polarization directions of 0° and 80° and the angle formed between the two polarized UV lights with polarization directions of 45° and 125° are each 80°). This configuration was found to cause no disclinations even when multiple polarized UV lights are unintentionally applied to the same irradiation region due to misalignment or other factors, so that a PBOE whose optical characteristics are maintained can be produced.

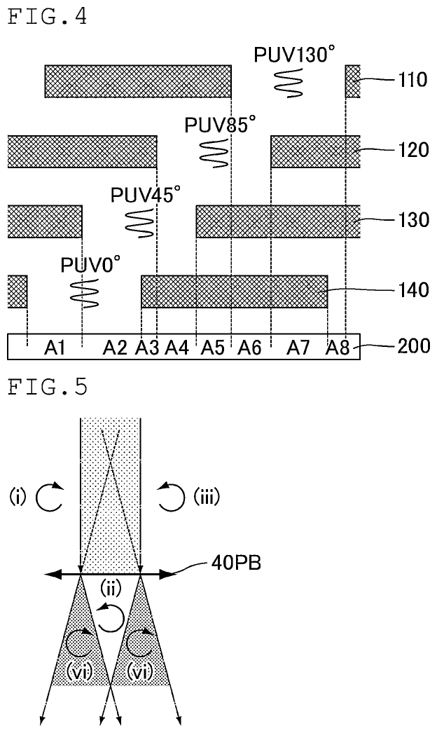

FIG. 4 is a view illustrating mask exposure according to the embodiment of the present invention. FIG. 4 shows a case where four photomasks are used to expose the photoalignment film 200 to light; the first photomask 140 is used to apply polarized UV light with a polarization direction of 0°, the second photomask 130 is used to apply polarized UV light with a polarization direction of 45°, the third photomask 120 is used to apply polarized UV light with a polarization direction of 85°, and the fourth photomask 110 is used to apply polarized UV light with a polarization direction of 130°. This exposure process forms the following irradiation regions A1 to A8 on the photoalignment film 200.
Irradiation region A1: region irradiated only with polarized UV light with a polarization direction of 0° (non-overlapping region)
Irradiation region A2: region irradiated with polarized UV light with a polarization direction of 0° and polarized UV light with a polarization direction of 45° (overlapping region)
Irradiation region A3: region irradiated only with polarized UV light with a polarization direction of 45° (non-overlapping region)
Irradiation region A4: region irradiated with polarized UV light with a polarization direction of 45° and polarized UV light with a polarization direction of 85° (overlapping region)
Irradiation region A5: region irradiated only with polarized UV light with a polarization direction of 85° (non-overlapping region)
Irradiation region A6: region irradiated with polarized UV light with a polarization direction of 85° and polarized UV light with a polarization direction of 130° (overlapping region)
Irradiation region A7: region irradiated only with polarized UV light with a polarization direction of 130° (non-overlapping region)
Irradiation region A8: region irradiated with polarized UV light with a polarization direction of 130° and polarized UV light with a polarization direction of 0° (overlapping region)

The photoalignment film 200 in the irradiation region A1 forms an alignment domain (first alignment domain) where the reference alignment azimuth is 0°. The photoalignment film 200 in the irradiation region A2 forms an alignment domain (second alignment domain) where the reference alignment azimuth is 22.5°. The photoalignment film 200 in the irradiation region A3 forms an alignment domain (first alignment domain) where the reference alignment azimuth is 45°. The photoalignment film 200 in the irradiation region A4 forms an alignment domain (second alignment domain) where the reference alignment azimuth is 65°. The photoalignment film 200 in the irradiation region A5 forms an alignment domain (first alignment domain) where the reference alignment azimuth is 85°. The photoalignment film 200 in the irradiation region A6 forms an alignment domain (second alignment domain) where the reference alignment azimuth is 107.5°. The photoalignment film 200 in the irradiation region A7 forms an alignment domain (first alignment domain) where the reference alignment azimuth is 130°. The photoalignment film 200 in the irradiation region A8 forms an alignment domain (second alignment domain) where the reference alignment azimuth is 155°.

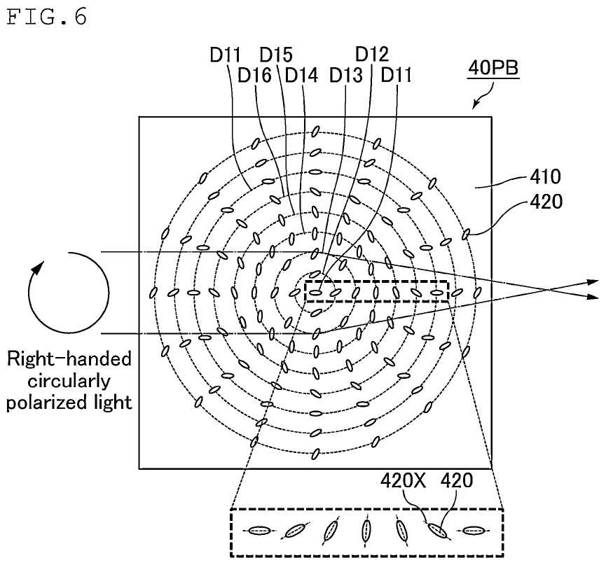

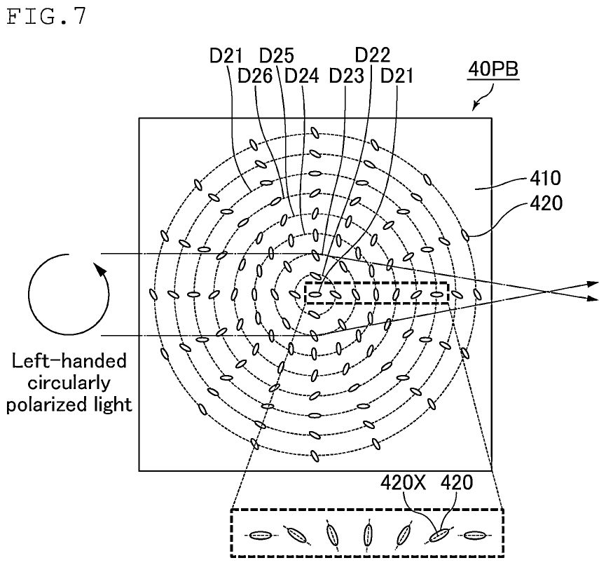

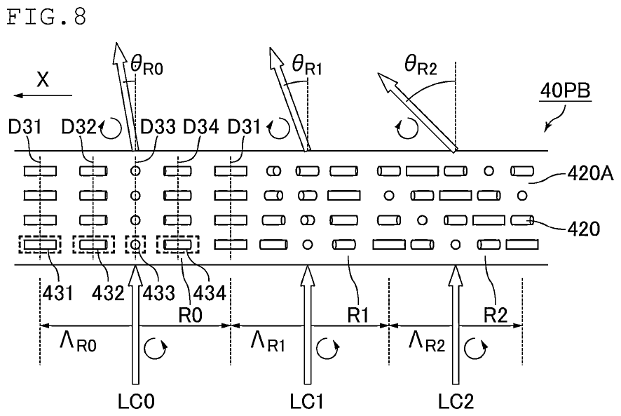

The PB lens, which is a type of the PBOE, is described in detail with reference to FIGS. 5 to 8. FIG. 5 is a schematic view illustrating an example of convergence and divergence of light through a PB lens. FIG. 6 and FIG. 7 are plan views each showing an example of a PB lens according to the embodiment of the present invention. FIG. 8 is an example of a schematic cross-sectional view of a PB lens according to the embodiment of the present invention.

A PB lens 40PB causes one of left-handed circularly polarized light and right-handed circularly polarized light incident thereon to converge while causing the other circularly polarized light incident thereon to diverge. The PB lens 40PB can function as, for example, a lens whose focal length is switchable between f and −f for left-handed circularly polarized light and right-handed circularly polarized light. As shown in FIG. 5, for example, the PB lens 40PB causes one of left-handed circularly polarized light and right-handed circularly polarized light incident thereon to converge while reversing the handedness of the circularly polarized light, and causes the other of the left-handed circularly polarized light and the right-handed circularly polarized light incident thereon to diverge while reversing the handedness of the circularly polarized light.

Specifically, as shown in FIG. 5, right-handed circularly polarized light ((i) in FIG. 5) incident on the PB lens 40PB is reversed to left-handed circularly polarized light to converge ((ii) in FIG. 5). Left-handed circularly polarized light ((iii) in FIG. 5) incident on the PB lens 40PB is reversed to right-handed circularly polarized light to diverge ((iv) in FIG. 5). The handedness of circularly polarized light incident on the PB lens 40PB is switched as described above to switch between divergence and convergence at the focal point f. Also, the handedness of circularly polarized light emerging from the PB lens 40PB is reverse to the handedness of circularly polarized light incident on the PB lens 40PB.

As shown in FIGS. 6 and 7, the PB lens 40PB includes a supporting substrate 410 and liquid crystal molecules 420 disposed on the supporting substrate 410 and periodically aligned. The periodic alignment of the liquid crystal molecules 420 causes diffraction to achieve the lens function. The PB lens 40PB is a diffractive lens.

The PB lens 40PB has one of the following two structures: the structure in which major axes 420X of the liquid crystal molecules 420 rotate counterclockwise from the center toward the outside as shown in FIG. 6; and the structure in which the major axes 420X of the liquid crystal molecules 420 rotate clockwise from the center toward the outside as shown in FIG. 7. These structures are different in their action on polarized light.

The liquid crystal layer in the PB lens 40PB shown in FIG. 6 includes alignment domains with reference alignment azimuths being designed to be 0°, 30°, 60°, 85°, 110°, and 145°. In the PB lens 40PB in FIG. 6, (1) the alignment domain D11 where the reference alignment azimuth is 0°, the alignment domain D12 where the reference alignment azimuth is 30°, the alignment domain D13 where the reference alignment azimuth is 60°, the alignment domain D14 where the reference alignment azimuth is 85°, the alignment domain D15 where the reference alignment azimuth is 110°, and the alignment domain D16 where the reference alignment azimuth is 145° may all correspond to the first alignment domains, or (2) the alignment domain D11 where the reference alignment azimuth is 0°, the alignment domain D13 where the reference alignment azimuth is 60°, and the alignment domain D15 where the reference alignment azimuth is 110° may correspond to the first alignment domains and the alignment domain D12 where the reference alignment azimuth is 30°, the alignment domain D14 where the reference alignment azimuth is 85°, and the alignment domain D16 where the reference alignment azimuth is 145° may correspond to the second alignment domains.

The liquid crystal layer in the PB lens 40PB shown in FIG. 7 includes alignment domains including first alignment domains with reference alignment azimuths of) 180° (0°), 150° (−30°), 120° (−60°), 95° (−85°), 70° (−110°, and 35° (−145°). The PB lens 40PB in FIG. 7 may be in a mode (1) in which the alignment domain D21 where the reference alignment azimuth is 180°, the alignment domain D22 where the reference alignment azimuth is 150°, the alignment domain D23 where the reference alignment azimuth is 120°, the alignment domain D24 where the reference alignment azimuth is 95°, the alignment domain D25 where the reference alignment azimuth is 70°, and the alignment domain D26 where the reference alignment azimuth is 35° all correspond to the first alignment domains, or a mode (2) in which the alignment domain D21 where the reference alignment azimuth is 180°, the alignment domain D23 where the reference alignment azimuth is 120°, and the alignment domain D25 where the reference alignment azimuth is 70° correspond to the first alignment domains and the alignment domain D22 where the reference alignment azimuth is 150°, the alignment domain D24 where the reference alignment azimuth is 95°, and the alignment domain D26 where the reference alignment azimuth is 35° correspond to the second alignment domains.

The PB lens 40PB can be produced by, for example, the method disclosed in WO 2019/189818.

The PB lens 40PB includes, as shown in FIG. 8, a liquid crystal layer 420A containing the liquid crystal molecules 420. The PB lens 40PB transmits incident circularly polarized light by diffracting the light in a predetermined direction, for example. The incident light in FIG. 8 is left-handed circularly polarized light.

The portion of the liquid crystal layer 420A shown in FIG. 8 includes three regions R0, R1, and R2 from the left in FIG. 8, and the regions have different lengths Λ of one period. Specifically, the order of length Λ of one period is regions R0, R1, and R2, from longest to shortest. Although FIG. 8 shows three regions R0, R1, and R2, the number of the regions is not limited. The regions R1 and R2 may each have a structure in which the optic axis is twist-rotated in the thickness direction of the liquid crystal layer 420A (hereinafter, also referred to as a twisted structure). A stack of two layers having such a twisted structure can be used to increase the diffraction efficiency when the wavelength range or angle of incidence is wide.

Each of the three regions R0, R1, and R2 includes alignment domains D31, D32, D33, and D34, and the reference alignment azimuths of the alignment domains are different. With a portion of the liquid crystal layer 420A adjoining to the photoalignment film being defined as an adjoining portion, the reference alignment azimuths of these alignment domains respectively correspond to the alignment azimuths of the liquid crystal molecules 431, 432, 433, and 434 in the centers of the adjoining portions inside these alignment domains.

Left-handed circularly polarized light LC1 incident on the in-plane region R1 of the liquid crystal layer 420A is transmitted after being diffracted at a predetermined angle in the direction of the arrow X, i.e., one direction in which the orientation of the optic axis of the liquid crystal molecules 420 varies while rotating continuously, from the incident direction. Similarly, left-handed circularly polarized light LC2 incident on the in-plane region R2 of the liquid crystal layer 420A is transmitted after being diffracted at a predetermined angle in the direction of the arrow X from the incident direction. Also, left-handed circularly polarized light LC0 incident on the in-plane region R0 of the liquid crystal layer 420A is transmitted after being diffracted at a predetermined angle in the direction of the arrow X from the incident direction.

The one period Λ_{R2} of the liquid crystal alignment pattern of the region R2 is shorter than the one period Ari of the liquid crystal alignment pattern of the region R1. Thus, in the liquid crystal layer 420A, as shown in FIG. 8, the angle of diffraction θ_{R2} provided to light incident on and transmitted through the region R2 is larger than the angle of diffraction θ_{R1} provided to light incident on and transmitted through the region R1. Also, the one period Λ_{R0} of the liquid crystal alignment pattern of the region R0 is longer than the one period Ami of the liquid crystal alignment pattern of the region R1. Thus, as shown in FIG. 8, the angle of diffraction Oro provided to light incident on and transmitted through the region R0 is smaller than the angle of diffraction OR provided to light incident on and transmitted through the region R1.

Here, diffraction of light by the liquid crystal layer having a liquid crystal alignment pattern in which the orientation of the optic axis of the liquid crystal molecules varies while continuously rotating in a plane involves an issue that the diffraction efficiency decreases as the angle of diffraction increases, i.e., the intensity of the diffracted light decreases. This means that when the liquid crystal layer has a structure including regions with different lengths of one period, in which the orientation of the optic axis of the liquid crystal molecules is rotated by 180° in the plane, the angle of diffraction differs depending on the position of incidence of light, resulting in a difference in quantity of diffracted light depending on the in-plane position of incidence of light. In other words, the structure produces a region where transmitted, diffracted light weakens at certain in-plane positions of incidence of light.

Meanwhile, the PB lens 40PB of the present embodiment includes the regions where liquid crystal molecules are twist-rotated in the thickness direction in the liquid crystal layer 420A and the twist angle in the thickness direction differs from region to region. In the example in FIG. 8, the twist angle ore in the thickness direction of the region R2 is larger than the twist angle φ_{R1} in the thickness direction of the region R1 in the liquid crystal layer 420A. The region R0 has no twisted structure in the thickness direction. This can reduce or prevent a decrease in diffraction efficiency of diffracted light.

In the example in FIG. 8, the regions R1 and R2 larger in angle of diffraction than the region R0 each have a twisted structure. This can reduce or prevent a decrease in quantity of light diffracted by the regions R1 and R2. Also, the region R2 larger in angle of diffraction than the region R1 is also larger in twist angle of the twisted structure than the region R1. This can reduce or prevent a decrease in quantity of light diffracted by the region R2. The configuration can equalize the quantities of transmitted lights regardless of the in-plane positions of incidence of light.

As described above, in an in-plane region where the liquid crystal layer 420A provides a large angle of diffraction in the PB lens 40PB of the present embodiment, incident light is diffracted by passing through a layer with a large twist angle in the thickness direction. Meanwhile, in an in-plane region where the liquid crystal layer 420A provides a small angle of diffraction, incident light is diffracted by passing through a layer with a small twist angle in the thickness direction. In other words, the PB lens 40PB can produce transmitted light brighter than incident light by setting the in-plane twist angle in the thickness direction according to the angle of diffraction provided by the liquid crystal layer 420A. Thus, the PB lens 40PB can reduce the diffraction angle dependence of the quantity of transmitted light in the plane.

The angle of light diffraction in the plane of the liquid crystal layer 420A increases as the one period Λ of the liquid crystal alignment pattern becomes shorter. Also, the twist angle in the thickness direction in the plane of the liquid crystal layer 420A is larger in a region with a short one period Λ, in which the orientation of the optic axis rotates by 180° in the direction of the arrow X in the liquid crystal alignment pattern, than in a region with a long one period A. In the PB lens 40PB, for example, as shown in FIG. 8, the one period Λ_{R2} of the liquid crystal alignment pattern in the region R2 of the liquid crystal layer 420A is shorter than the one period Λ_{R1} of the liquid crystal alignment pattern in the region R1, and the twist angle φ_{R2} in the thickness direction is larger than the twist angle φ_{R1}. In other words, the region R2 in the liquid crystal layer 420A on the light incident side more diffracts light.

Thus, when the in-plane twist angle φ in the thickness direction is set for the one period Λ of the liquid crystal alignment pattern in question, the transmitted lights diffracted at different angles in different in-plane regions can be suitably brighter.

In the PB lens 40PB, as described above, since the angle of diffraction increases as the one period Λ of the liquid crystal alignment pattern becomes shorter, a larger twist angle in the thickness direction is set for a region with a shorter one period Λ of the liquid crystal alignment pattern, so that the transmitted light can be brighter. Thus, in the PB lens 40PB, preferably, the regions with different lengths of one period of the liquid crystal alignment pattern include regions where the order of length of one period and the order of twist angle in the thickness direction are different.

The PB lens 40PB preferably includes the liquid crystal layer 420A formed from a liquid crystal composition containing the liquid crystal molecules 420. The liquid crystal layer 420A preferably includes regions each of which has a liquid crystal alignment pattern with the orientation of the optic axis of the liquid crystal molecules varying while continuously rotating in at least one in-plane direction, and in which the optic axis is preferably twist-rotated in the thickness direction of the liquid crystal layer 420A. The twist angle in the thickness direction preferably differs from region to region.

Preferably, the PB lens 40PB includes regions with different lengths of one period in the liquid crystal alignment pattern, where the one period is the length in which the orientation of the optic axis of the liquid crystal molecules 420 is rotated by 180° in the plane.

Preferably, the liquid crystal layer 420A includes the regions with different lengths of one period in the liquid crystal alignment pattern arranged by length of one period, and the regions with different twist angles in the thickness direction arranged by twist angle in the thickness direction, wherein the direction of the arrangement by length of one period and the direction of the arrangement by twist angle in the thickness direction are different.

Preferably, the liquid crystal layer 420A includes regions where the twist angle in the thickness direction is 10° to 360°.

Preferably, in the liquid crystal layer 420A, the one period of the liquid crystal alignment pattern becomes shorter gradually in the one direction in which the orientation of the optic axis of the liquid crystal molecules 420 in the liquid crystal alignment pattern varies while continuously rotating.

Preferably, the liquid crystal alignment pattern of the liquid crystal layer 420A is a concentric circular pattern where the one direction, in which the orientation of the optic axis of the liquid crystal molecules 420 varies while continuously rotating, lies from the inside toward the outside.

The PB lens 40PB in FIG. 8 is a PB lens with the twist angle varying in the plane, and is an element having a high diffraction efficiency even when the angle of diffraction is large. Yet, the PB lens 40PB may be a PB lens with the twist angle not varying in the plane. Specifically, the PB lens 40PB may be a PB lens without a twist in the thickness direction or with a constant twist angle in the plane. For example, the polarization diffraction grating disclosed in JP 2008-532085 T can be used.

Preferably, the PB lens 40PB is a PB lens including multiple liquid crystal layers 420A, and the liquid crystal layers 420A are different from one another in orientation of the twist angle in the thickness direction of the liquid crystal layers 420A.

Preferably, the PB lens 40PB is a PB lens including multiple liquid crystal layers 420A, and the liquid crystal layers 420A are different from one another in twist angle in the thickness direction of the liquid crystal layers 420A.

Preferably, the PB lens 40PB is a PB lens including multiple liquid crystal layers 420A, and the liquid crystal layers 420A have liquid crystal alignment patterns that are the same as one another in the at least one in-plane direction in which the orientation of the optic axis of the liquid crystal molecules 420 continuously rotates.

Preferably, the length of one period in the liquid crystal alignment pattern is 50 μm or shorter.

### EXPERIMENTAL EXAMPLES

Samples were actually produced by photoalignment treatment including dividing a photoalignment film into three irradiation regions and irradiating the irradiation regions with different polarized lights through a photomask. The samples were used to compare a case where the difference in polarization direction between the polarized lights applied to two irradiation regions was 90° (Experimental Example 1) to cases where the difference in polarization direction was not 90° (Experimental Examples 2 to 4).

### Experimental Example 1

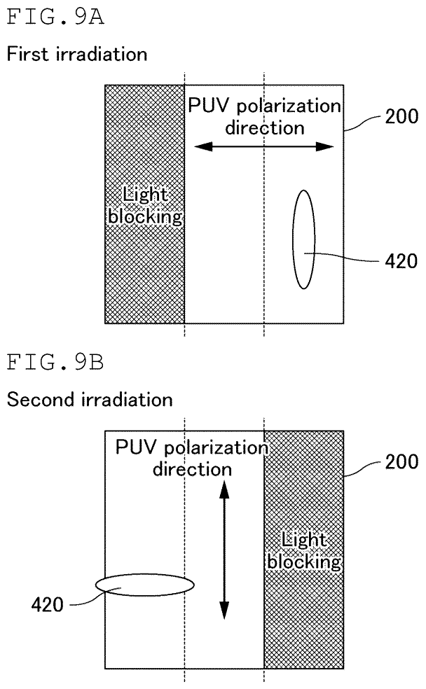

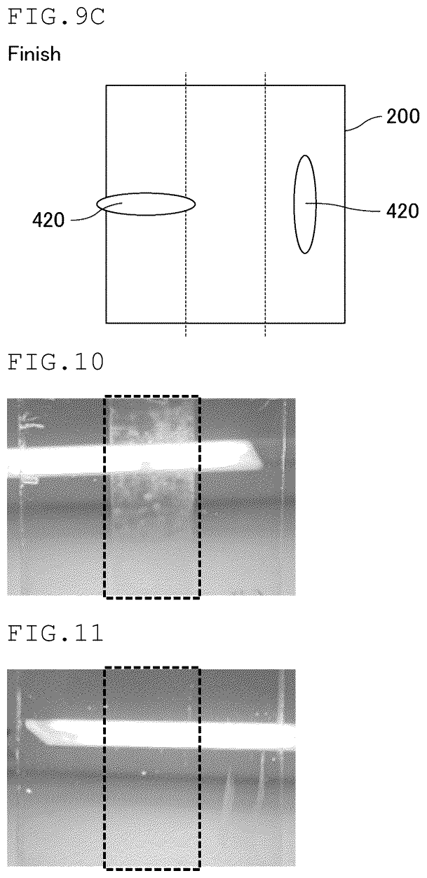

The sample was produced by dividing a photoalignment film into three irradiation regions and irradiating the two outer irradiation regions with different polarized lights such that the difference in polarization direction between the polarized lights was 90°. FIGS. 9A, 9B, and 9C are views illustrating an irradiation method with polarized lights in Experimental Example 1.

### (Sample Production Procedure)

An alignment film material containing a photoalignment polymer with a photo-functional group was applied to a square glass substrate and then dried to form a photoalignment film before alignment treatment.

The photoalignment film was irradiated with polarized UV light twice. The polarized UV light was linearly polarized UV light produced by causing light from a UV lamp light source to pass through a wire grid polarizer. As shown in FIG. 9A, the first polarized UV irradiation was performed with the left ⅓ region of a photoalignment film 200 being hidden by a light blocking material (aluminum film). The polarization direction of the polarized UV light in the first irradiation was 0° (reference azimuth). As shown in FIG. 9B, the second polarized UV irradiation was performed with the right ⅓ region of the photoalignment film 200 being hidden by a light blocking material (aluminum film). The second irradiation was performed such that the polarization direction of the polarized UV light was 90°. The wavelength of the polarized UV light was 365 nm and the cumulative dose was 100 mJ/cm².

As a result of the second polarized UV irradiation described above, as shown in FIG. 9C, the right ⅓ region of the photoalignment film 200 was irradiated only with the polarized UV light with a polarization direction of 0°, the left ⅓ region of the photoalignment film 200 was irradiated only with the polarized UV light with a polarization direction of 90°, and the central ⅓ region of the photoalignment film 200 was irradiated with both the polarized UV light with a polarization direction of 0° and the polarized UV light with a polarization direction of 90°.

Thereafter, the photoalignment film 200 was left to stand at 160° C. for 20 minutes and coated with a liquid crystal (reactive mesogen: RM) using a spin coater that rotated at 1000 rpm. After the coating, the photoalignment film 200 was left to stand at 60° C. for 60 seconds, and then irradiated with unpolarized UV light (wavelength: 365 nm) with a dose of 200 mJ/cm². As a result, the sample was produced which included the photoalignment film on the glass substrate and the liquid crystal layer on the photoalignment film.

### Evaluation Method

The orientations of the slow axes of the liquid crystal layer in the right ⅓ region and left ⅓ region of the photoalignment film were each measured with a polarization property measurement system “Axoscan” available from Axometrics, Inc. The angle between the two slow axes was determined.

The haze (turbidity) values in the right ⅓ region and central ⅓ region of the photoalignment film were each measured with “NDH2000” available from Nippon Denshoku Industries Co., Ltd. The haze is defined as (diffuse transmittance)/(total light transmittance).

### Evaluation Result of Experimental Example 1

The measurement showed that the angle between the two slow axes in the right ⅓ region and the left ⅓ region of the photoalignment film was 90°, which was the same as the difference in polarization direction between the polarized UV lights applied to the right ⅓ region and left ⅓ region of the photoalignment film. The right ⅓ region of the photoalignment film corresponds to the region not irradiated with overlapping polarized UV lights. The central ⅓ region of the photoalignment film corresponds to the region irradiated with overlapping polarized UV lights.

The haze of the right ⅓ region of the photoalignment film was 0.20%, whereas the haze of the central ⅓ region of the photoalignment film was 2.70%. FIG. 10 is a photograph showing the sample of Experimental Example 1. As shown in FIG. 10, the central ⅓ region (region irradiated with overlapping polarized UV lights) of the photoalignment film appeared turbid in observation with the naked eye.

The difference in haze between the two regions corresponds to the difference in haze between the region not irradiated with overlapping polarized UV lights (right ⅓ region of the photoalignment film) and the region irradiated with overlapping polarized UV lights (central ⅓ region of the photoalignment film). The difference in haze was as large as 2.50% in Experimental Example 1.

### Experimental Example 2

In Experimental Example 2, the sample was produced and evaluated by procedures similar to those in Experimental Example 1, except that the difference in polarization direction between the polarized UV lights applied to the right ⅓ region and the left ⅓ region of the photoalignment film was 85°.

### Evaluation Result of Experimental Example 2

The measurement showed that the angle between the two slow axes in the right ⅓ region and the left ⅓ region of the photoalignment film was 85°, which was the same as the difference in polarization direction between the polarized UV lights applied to the right ⅓ region and the left ⅓ region of the photoalignment film. The right ⅓ region of the photoalignment film corresponds to the region not irradiated with overlapping polarized UV lights. The central ⅓ region of the photoalignment film corresponds to the region irradiated with overlapping polarized UV lights.

The haze of the right ⅓ region of the photoalignment film was 0.20%, whereas the haze of the central ⅓ region of the photoalignment film was 0.25%. FIG. 11 is a photograph showing the sample of Experimental Example 2. As shown in FIG. 11, the central ⅓ region (region irradiated with overlapping polarized UV lights) of the photoalignment film was not turbid in observation with the naked eye. The haze is preferably 0.30% or lower.

The difference in haze between the two regions corresponds to the difference un haze between the region not irradiated with overlapping polarized UV lights (right ⅓ region of the photoalignment film) and the region irradiated with overlapping polarized UV lights (central ⅓ region of the photoalignment film). The difference in haze in Experimental Example 2 was 0.05%, which was significantly smaller than the result in Experimental Example 1. The smaller the difference in haze between the two regions, the more the occurrence of disclinations can be reduced or prevented. Thus, a smaller difference in haze is more suitable for production of a Pancharatnam-Berry phase optical element with favorable optical characteristics. The difference in haze between the two regions is preferably 0.10% or smaller.

The results above show that with a difference in polarization direction between polarized UV lights of 85°, the occurrence of disclinations can be reduced or prevented and the haze can be lower, so that a Pancharatnam-Berry phase optical element with favorable optical characteristics can be obtained.

### Experimental Example 3

In Experimental Example 3, the sample was produced and evaluated by procedures similar to those in Experimental Example 1, except that the difference in polarization direction between the polarized UV lights applied to the right ⅓ region and the left ⅓ region of the photoalignment film was 70°.

### Evaluation Result of Experimental Example 3

The measurement showed that the angle between the two slow axes in the right ⅓ region and the left ⅓ region of the photoalignment film was 70°, which was the same as the difference in polarization direction between the polarized UV lights applied to the right ⅓ region and the left ⅓ region of the photoalignment film. The right ⅓ region of the photoalignment film corresponds to the region not irradiated with overlapping polarized UV lights. The central ⅓ region of the photoalignment film corresponds to the region irradiated with overlapping polarized UV lights.

The haze of the right ⅓ region of the photoalignment film was 0.20%, whereas the haze of the central ⅓ region of the photoalignment film was 0.20%.

The difference in haze between the two regions corresponds to the difference between the region not irradiated with overlapping polarized UV lights (right ⅓ region of the photoalignment film) and the region irradiated with overlapping polarized UV lights (central ⅓ region of the photoalignment film). The difference in haze in Experimental Example 3 was 0.00%, which was significantly smaller than the result in Experimental Example 1.

The results above show that with a difference in polarization direction between polarized UV lights of 70°, the occurrence of disclinations can be reduced or prevented and the haze can be lower, so that a Pancharatnam-Berry phase optical element with favorable optical characteristics can be obtained.

### Experimental Example 4

In Experimental Example 4, the sample was produced and evaluated by procedures similar to those in Experimental Example 1, except that the difference in polarization direction between the polarized UV lights applied to the right ⅓ region and the left ⅓ region of the photoalignment film was 45°.

### Evaluation Result of Experimental Example 4

The measurement showed that the angle between the two slow axes in the right ⅓ region and the left ⅓ region of the photoalignment film was 45°, which was the same as the difference in polarization direction between the polarized UV lights applied to the right ⅓ region and the left ⅓ region of the photoalignment film. The right ⅓ region of the photoalignment film corresponds to the region not irradiated with overlapping polarized UV lights. The central ⅓ region of the photoalignment film corresponds to the region irradiated with overlapping polarized UV lights.

The haze of the right ⅓ region of the photoalignment film was 0.20%, whereas the haze of the central ⅓ region of the photoalignment film was 0.20%.

The difference in haze between the two regions corresponds to the difference in haze between the region not irradiated with overlapping polarized UV lights (right ⅓ region of the photoalignment film) and the region irradiated with overlapping polarized UV lights (central ⅓ region of the photoalignment film). The difference in haze in Experimental Example 4 was 0.00%, which was significantly smaller than the result in Experimental Example 1.

The results above show that with a difference in polarization direction between polarized UV lights of 45°, the occurrence of disclinations can be reduced or prevented and the haze can be lower, so that a Pancharatnam-Berry phase optical element with favorable optical characteristics can be obtained.

### EXAMPLES

### Examples and Comparative Examples

The effects of the present invention are described based on an example and a comparative example below. The example, however, is not intended to limit the scope of the present invention.

### Comparative Example 1

A Pancharatnam-Berry phase optical element (PB lens) was actually produced by photoalignment treatment including dividing a photoalignment film into irradiation regions and irradiating the irradiation regions with different polarized lights through a photomask. The differences in polarization direction between the polarized UV lights applied to the irradiation regions included a difference of 90°.

### (Production Procedure of PB Lens)

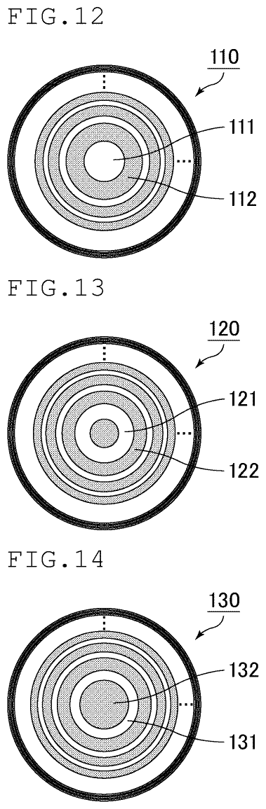

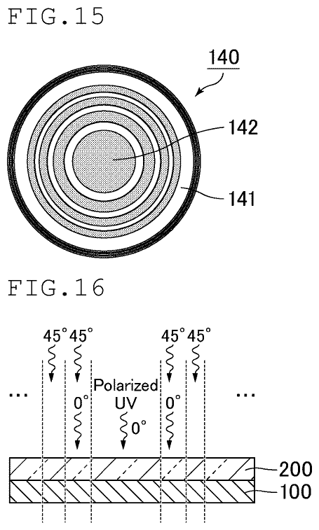

As shown in FIG. 16, an alignment film material containing a photoalignment polymer with a photo-functional group was applied to a glass substrate 100 and then dried to form a photo-isomerized photoalignment film 200, which was then irradiated with polarized UV lights with polarization directions of 0°, 45°, 90°, and 135°. The wavelengths of the polarized UV lights were 365 nm, and the cumulative dose was 100 mJ/cm². In the polarized UV irradiation, four types of photomasks were used according to the polarization direction of the polarized UV light. Each of the four types of photomasks was an annular photomask including concentrically repeated light transmitting portions and light blocking portions. Specifically, the photomask 110 including light transmitting portions 111 and light blocking portions 112 shown in FIG. 12 was used for polarized UV light with a polarization direction of 0°. A photomask 120 including light transmitting portions 121 and light blocking portions 122 shown in FIG. 13 was used for polarized UV light with a polarization direction of 45°. A photomask 130 including light transmitting portions 131 and light blocking portions 132 shown in FIG. 14 was used for polarized UV light with a polarization direction of 90°. A photomask 140 including light transmitting portions 141 and light blocking portions 142 shown in FIG. 15 was used for polarized UV light with a polarization direction of 135°. As shown in FIG. 16, the four types of photomasks were designed such that a region irradiated with overlapping polarized UV lights with different polarization directions (overlapping region) and a region not irradiated with overlapping polarized UV lights with different polarization directions (non-overlapping region) were alternately formed.

After the polarized UV irradiation, the photoalignment film 200 was baked in a 160° C. oven for 20 minutes and coated with a liquid crystal (reactive mesogen: RM) using a spin coater that rotated at 1000 rpm. The thickness of the coating film was set such that the film would provide a phase difference of λ/2 (about 266 nm) to light having a wavelength of 532 nm. After the coating, the photoalignment film 200 was left to stand at 60° C. for 60 seconds, and then irradiated with unpolarized UV light (wavelength: 365 nm) with a dose of 200 mJ/cm². As a result, a PB lens was produced which included the photoalignment film on the glass substrate and the liquid crystal layer on the photoalignment film.

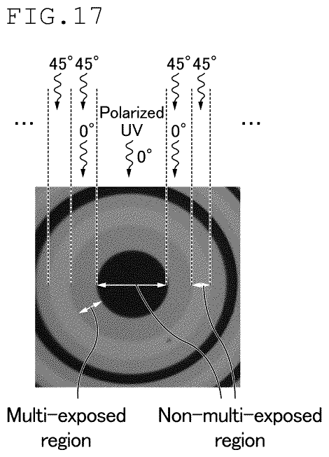

The obtained PB lens was observed with a polarizing microscope and confirmed that the liquid crystal molecules in the liquid crystal layer were normally aligned. FIG. 17 is a photograph of the PB lens of Comparative Example 1 observed with the polarizing microscope. The liquid crystal layer in the PB lens of Comparative Example 1 included alignment domains with reference alignment azimuths of 0°, 22.5°, 45°, 67.5°, 90°, 112.5°, 135°, and 157.5°. The alignment domains with reference alignment azimuths of 0°, 45°, 90°, and 135° correspond to the first alignment domains. The alignment domains with reference alignment azimuths of 22.5°, 67.5°, 112.5°, and 157.5° correspond to the second alignment domains. The liquid crystal layer in the PB lens of Comparative Example 1 included two first alignment domains between which the difference in reference alignment azimuth was 90° (two first alignment domains with reference alignment azimuths of 0° and 90°, two first alignment domains with reference alignment azimuths of 45° and) 135°.

### Evaluation Method

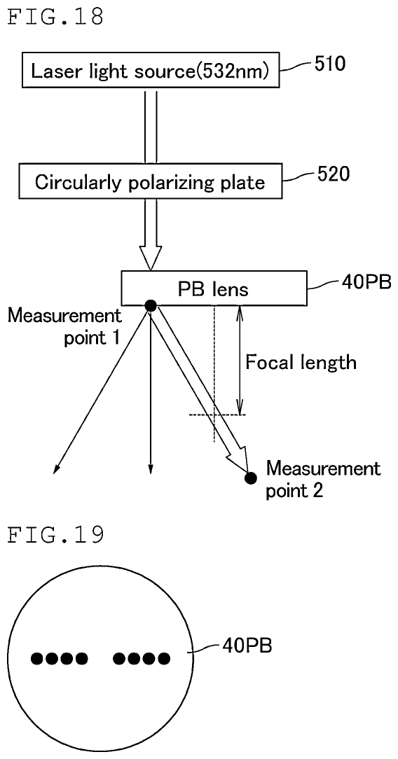

The optical characteristics of the PB lens were evaluated based on the diffraction efficiency. FIG. 18 is a view illustrating the method of measuring the diffraction efficiency. As shown in FIG. 18, the diffraction efficiency was measured using a laser light source 510 that emitted laser light with a wavelength of 532 nm, a circularly polarizing plate 520, and the PB lens 40PB.

Laser light emitted from the laser light source 510 passes through the circularly polarizing plate 520 to be emitted as circularly polarized light. Principal light of the light having passed through the outer periphery of the PB lens 40PB travels toward the focal point. Meanwhile, unnecessary light such as the zeroth-order light is diffracted in a different direction from the principal light. Thus, the light intensity was measured at the measurement point 1 (immediately after transmission through the PB lens) and the measurement point 2 (on the path of principal light and farther than the focal point) shown in FIG. 18. The light intensity measured at the measurement point 1 was taken as the total transmission light intensity. The light intensity measured at the measurement point 2 was taken as the principal light intensity. The diffraction efficiency (unit: %) was calculated from these measurement values using the following equation. Diffraction efficiency=(principal light intensity)/(total transmission light intensity)×100

The diffraction efficiency was measured by changing the position (indicated by the black dot (⋅) in FIG. 19) where laser light was transmitted through the PB lens as shown in FIG. 19, so that the minimum and maximum values were determined.

### Evaluation Result of Comparative Example 1

The PB lens of Comparative Example 1 produced by irradiating the irradiation regions of the photoalignment film with polarized UV lights with polarization directions of 0°, 45°, 90°, and 135° exhibited a measured minimum diffraction efficiency of 76.2% and a measured maximum diffraction efficiency of 95.3%. The diffraction efficiency presumably varied due to disclinations occurred in the plane of the PB lens.

### Example 1

A Pancharatnam-Berry phase optical element (PB lens) was actually produced by a photoalignment treatment including dividing a photoalignment film into irradiation regions and irradiating the irradiation regions with different polarized lights through a photomask. In the photoalignment treatment, the difference in polarization direction between polarized UV lights applied to the irradiation regions was not 90° (in other words, when the difference between two polarization directions was the acute angle out of the angles formed between the two polarization directions, the difference in polarization direction between the polarized UV lights applied to the irradiation regions was smaller than 90° (for example, 85° or smaller)). The PB lens was produced by a procedure similar to that in Comparative Example 1, except that the polarization directions of the polarized UV lights were set to 0°, 45°, 80°, and 125°. The diffraction efficiency was measured by a procedure similar to that in Comparative Example 1 to determine the minimum and maximum values.

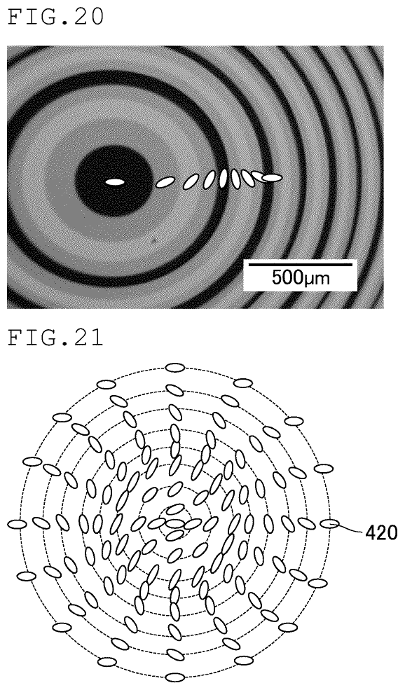

FIG. 20 is a photograph of the PB lens of Example 1 observed with a polarizing microscope. FIG. 21 is a view schematically showing liquid crystal alignment in the PB lens of Example 1. As shown in FIGS. 20 and 21, in the PB lens of Example 1, the liquid crystal layer included first alignment domains and second alignment domains with reference alignment azimuths of the liquid crystal molecules 420 being different from one another, and the difference in reference alignment azimuth between the first alignment domains was not 90° (in other words, when the difference between two reference alignment azimuths is the acute angle out of angles formed between two directions at the respective two reference alignment azimuths, the difference in reference alignment azimuth between the first alignment domains was smaller than 90° (for example, 85° or smaller)). The liquid crystal layer in the PB lens of Example 1 shown in FIG. 21 included first alignment domains with reference alignment azimuths of 0°, 45°, 80°, and 125°, and second alignment domains with reference alignment azimuths of 22.5°, 62.5°, 102.5°, and 152.5°.

### Evaluation Result of Example 1

The PB lens of Example 1 produced by irradiating the irradiation regions of the photoalignment film with polarized UV lights with the polarization directions of 0°, 45°, 80°, and 125° exhibited a measured minimum diffraction efficiency of 95.4% and a measured maximum diffraction efficiency of 97.3%. The PB lens of Example 1 exhibited higher diffraction efficiencies and less variation of diffraction efficiencies than the PB lens of Comparative Example 1. The comparison between Example 1 and Comparative Example 1 confirmed that the diffraction efficiency increases when the angle formed between the polarization directions of polarized UV lights is not 90°. This is presumably because occurrence of disclinations due to irradiation with overlapping orthogonal polarized UV lights was successfully prevented.

The PB lenses shown in FIG. 1 and FIG. 21 had a structure in which the major axes 420X of the liquid crystal molecules 420 rotated counterclockwise from the center toward the outside, but the structure may be one in which the major axes 420X of the liquid crystal molecules 420 rotate clockwise from the center toward the outside. The liquid crystal layer in the PB lens shown in FIG. 1 in the case of employing a clockwise rotation structure may include in order a first alignment domain where the reference alignment azimuth is) 180° (0°, a second alignment domain where the reference alignment azimuth is 157.5° (−22.5°), a first alignment domain where the reference alignment azimuth is 135° (−45°), a second alignment domain where the reference alignment azimuth is 115° (−65°), a first alignment domain where the reference alignment azimuth is 95° (−85°), a second alignment domain where the reference alignment azimuth is 72.5° (−107.5°), a first alignment domain where the reference alignment azimuth is 50° (−130°), and a second alignment domain where the reference alignment azimuth is 25° (−155°). The liquid crystal layer in the PB lens shown in FIG. 21 in the case of employing a clockwise rotation structure may include in order a first alignment domain where the reference alignment azimuth is 180° (0°), a second alignment domain where the reference alignment azimuth is 157.5° (−22.5°), a first alignment domain where the reference alignment azimuth is 135° (−45°), a second alignment domain where the reference alignment azimuth is 117.5° (−62.5°), a first alignment domain where the reference alignment azimuth is 100° (−80°), a second alignment domain where the reference alignment azimuth is 77.5° (−102.5°), a first alignment domain where the reference alignment azimuth is 55° (−125°), and a second alignment domain where the reference alignment azimuth is 27.5° (−152.5°).

The alignment domains in the liquid crystal layer in a PB diffraction grating are not limited to those in the example shown in FIG. 2. For example, the reference alignment azimuths of the alignment domains in the liquid crystal layer in the PB lens described above may be employed as the reference alignment azimuths of the alignment domains in the liquid crystal layer in the PB diffraction grating.

### REFERENCE SIGNS LIST

40PB: PB lens
100: glass substrate
110, 120, 130, 140: photomask
200: photoalignment film
410: supporting substrate
420: liquid crystal molecule
420A: liquid crystal layer
420X: major axis of liquid crystal molecule
510: laser light source
520: circularly polarizing plate
LC0, LC1, LC2: left-handed circularly polarized light
R0, R1, R2: region

What is claimed is:

1. A Pancharatnam-Berry phase optical element comprising:
a photoalignment film; and
a liquid crystal layer in contact with the photoalignment film,
the liquid crystal layer including alignment domains with reference alignment azimuths of liquid crystal molecules defined by the photoalignment film, the reference alignment azimuths being different from one another,
the alignment domains including first alignment domains and second alignment domains, with each of the second alignment domains being positioned between two of the first alignment domains and in contact with each of the two first alignment domains,
a difference in reference alignment azimuth between the first alignment domains being not 90°.

2. The Pancharatnam-Berry phase optical element according to claim 1,
wherein the first alignment domains include four or more types of alignment domains.

3. The Pancharatnam-Berry phase optical element according to claim 1,
wherein with a predetermined reference azimuth being set to 0°,
the first alignment domains include an alignment domain where the reference alignment azimuth is 0° but not an alignment domain where the reference alignment azimuth is 90°.

4. The Pancharatnam-Berry phase optical element according to claim 1,
wherein with a predetermined reference azimuth being set to 0°,
the first alignment domains include an alignment domain where the reference alignment azimuth is 0° and an alignment domain where the reference alignment azimuth is 80°, 85°, 95°, or 100°.

5. A Pancharatnam-Berry phase optical element comprising:
a photoalignment film; and
a liquid crystal layer in contact with the photoalignment film,
the liquid crystal layer including alignment domains with reference alignment azimuths of liquid crystal molecules defined by the photoalignment film, the reference alignment azimuths being different from one another,
a difference in reference alignment azimuth between the alignment domains being not 90°.

6. The Pancharatnam-Berry phase optical element according to claim 5,
wherein the alignment domains include four or more types of alignment domains.

7. The Pancharatnam-Berry phase optical element according to claim 5,
wherein with a predetermined reference azimuth being set to 0°,
the alignment domains include an alignment domain where the reference alignment azimuth is 0° but not an alignment domain where the reference alignment azimuth is 90°.

8. The Pancharatnam-Berry phase optical element according to claim 5,
wherein with a predetermined reference azimuth being set to 0°,
the alignment domains include an alignment domain where the reference alignment azimuth is 0° and an alignment domain where the reference alignment azimuth is 80°, 85°, 95°, or 100°.

9. The Pancharatnam-Berry phase optical element according to claim 1,
wherein in a plan view of the liquid crystal layer, the alignment domains are arranged in a first direction from one end to the other end in the first direction of the liquid crystal layer.

10. The Pancharatnam-Berry phase optical element according to claim 1,
wherein in a plan view of the liquid crystal layer, the alignment domains are arranged from a center toward an end of the liquid crystal layer, with outer alignment domains surrounding inner alignment domains.

11. The Pancharatnam-Berry phase optical element according to claim 1,
wherein with a portion of the liquid crystal layer adjoining to the photoalignment film being defined as an adjoining portion,
the reference alignment azimuth of each of the alignment domains corresponds to an alignment azimuth of liquid crystal molecules in a center of the adjoining portion inside the alignment domain.

12. A method of producing a Pancharatnam-Berry phase optical element, the method comprising:
a photoalignment treatment performed on a photoalignment film,
the photoalignment treatment including dividing the photoalignment film into irradiation regions and irradiating the irradiation regions with different polarized lights through a photomask,
a difference in polarization direction between the polarized lights applied to the irradiation regions is not 90°.

13. The method of producing a Pancharatnam-Berry phase optical element according to claim 12,
wherein each of the irradiation regions includes a non-overlapping region not overlapping another irradiation region and an overlapping region overlapping another irradiation region.
